(19) United States
(12) Patent Application Publication
(10) Pub. No.: US 2009/0241266 A1
(43) Pub. Date: Oct. 1, 2009

(54) WASHER AND DRYER SHEET WITH VISUAL INDICATOR

(75) Inventors: Patrick Thielke, Houston, TX (US); Eddie L. Caruthers, III, Dallas, TX (US); David Bilbro, Harrisburg, NC (US)

Correspondence Address: OSHA LIANG L.L.P., TWO HOUSTON CENTER, 909 FANNIN, SUITE 3500, HOUSTON, TX, 77010, US

(73) Assignee: Consumer Solutions, Inc., Houston, TX (US)

(21) Appl. No.: 12/412,234

(22) Filed: Mar. 26, 2009

Related U.S. Application Data
(60) Provisional application No. 61/039,518, filed on Mar. 26, 2008.

(51) Int. Cl. D06L 1/00; C11D 17/00

(52) U.S. Cl. 8/137; 510/295

(57) ABSTRACT

A washer and dryer sheet having a substrate including a first visual indicator, a washer composition including a second visual indicator, wherein the second visual indicator is removed during a wash cycle, and a dryer composition including a third visual indicator, wherein the third visual indicator is removed during a dry cycle. Also, a method of washing a drying an object, the method including disposing a washer and dryer sheet having at least two visual indicators in a washing machine, contacting the object and the washer and dryer sheet with waster, removing the washer and dryer sheet from the washing machine, and exposing the object and the washer and dryer sheet to a heat source.

### CROSS-REFERENCE TO RELATED APPLICATIONS

The present application claims priority to U.S. Provisional Application Ser. No. 61/039,518, filed Mar. 26, 2008, and is hereby incorporated by reference in its entirety.

### BACKGROUND

1. Field of the Disclosure

Embodiments disclosed herein relate generally to washer and dryer sheets having visual indicators disposed thereon. More specifically, embodiments disclosed herein relate to washer and dryer sheets having visual indicators for identification of surfactant and/or fabric softener removal during washing and drying cycles.

2. Background Art

Laundry detergents are commonly dispensed into washing machines by measuring various amounts of liquid or powder detergents into cups or other measuring devices. This is inconvenient and wastes the consumer's time to have to measure out the correct amount of detergent for each load of laundry. When such liquid or powder detergents are measured out into cups or other measuring devices, there exists a common problem of spillage of detergents around the washing machine. Additionally, consumers typically purchase fabric softeners for use during either the wash or dry cycle. The fabric softeners may be supplied in either sheet or liquid form, however, regardless of the form the softeners are supplied in, the consumer must purchase two separate items.

To overcome such issues, various alternative methods of supplying detergent and fabric softeners have been attempted. One such method included the use of a detergent pouch, which is held together with a water soluble adhesive. Theoretically, the pouch becomes unglued in the wash water and release detergent chemicals into the washing machine. However, the detergent chemicals in the pouch sometimes form clumps which do not break or solubilize to release detergent into the wash water. Also, residual detergent chemicals may remain on the clothes if the detergent in the pouch forms insoluble clumps.

Regardless of whether pouches of detergent or measured power/liquids are used during wash cycles, the consumer still has to purchase two separate items, a detergent and a fabric softener. An alternative method of supplying detergent and fabric softener for wash and dry cycles is through the use of a combination washer and dryer sheet. Such washer and dryer sheets may contain detergents and fabric softeners, and as such, may be transferred with clothing from a washer directly to a dryer. However, such combination washer and dryer sheets do not allow a user to determine whether substantially all of the detergent has been released from the washer and dryer sheet prior to use in a drying cycle. As such, residual detergent may inadvertently be released from the washer and dryer sheet during the drying cycle, potentially damaging closing, or other wise resulting in an ineffective wash and dry process.

Accordingly, there exists a need for determining the composition of washer and dryer sheets during wash and dry cycles.

### SUMMARY OF THE DISCLOSURE

In one aspect, embodiments disclosed herein relate to a washer and dryer sheet having a substrate including a first visual indicator, a washer composition including a second visual indicator, wherein the second visual indicator is removed during a wash cycle, and a dryer composition including a third visual indicator, wherein the third visual indicator is removed during a dry cycle.

In another aspect, embodiments disclosed herein relate to a method of washing a drying an object, the method including disposing a washer and dryer sheet having at least two visual indicators in a washing machine, contacting the object and the washer and dryer sheet with waster, removing the washer and dryer sheet from the washing machine, and exposing the object and the washer and dryer sheet to a heat source.

Other aspects and advantages of the invention will be apparent from the following description and the appended claims.

### BRIEF DESCRIPTION OF DRAWINGS

FIG. 1 is a top view of a washer and dryer sheet according to embodiments of the present disclosure.

FIG. 2 is a side perspective view of a washer and dryer sheet according to embodiments of the present disclosure.

FIGS. 3A-3C are top views of a washer and dryer sheet during use according to embodiments of the present disclosure.

FIGS. 4A-4C are top views of a washer and dryer sheet during use according to embodiments of the present disclosure.

FIGS. 5A-5C are top views of a washer and dryer sheet during use according to embodiments of the present disclosure.

### DETAILED DESCRIPTION

In one aspect, embodiments disclosed herein relate to washer and dryer sheets having visual indicators disposed thereon. More specifically, embodiments disclosed herein relate to washer and dryer sheets having visual indicators for identification of surfactant and/or fabric softener removal during washing and drying cycles.

The present disclosure relates to washer and dryer sheets that include visual indicators that, for example, change color during wash and dry cycles such that an individual will know whether surfactants and other compositions required for effective washing, and fabric softeners and other compositions required for effective drying, have been removed from the washer and dryer sheet. Embodiments disclosed herein may thus allow an individual to wash one or more objects in, for example, a washing machine, by disposing a washer and dryer sheet directly in the washing machine. After the wash cycle, the objects, as well as the washer and dryer sheet, may be transferred to a dryer, for completion of the process in a drying cycle.

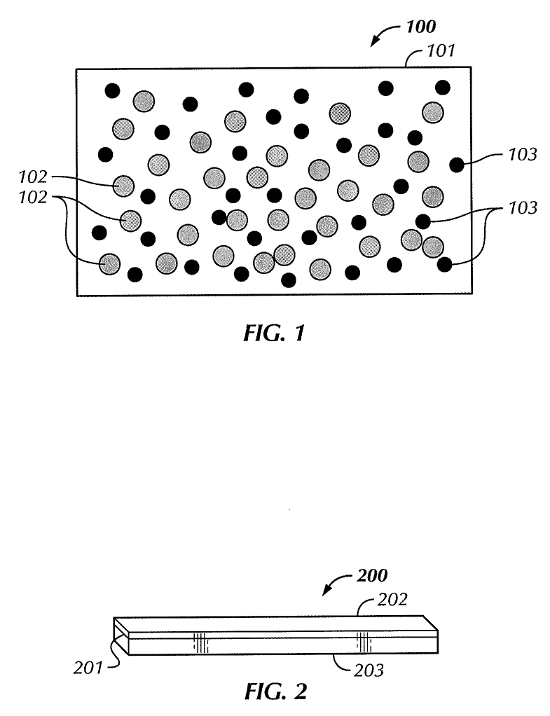

Referring to FIG. 1, a washer and dryer sheet 100 according to embodiments of the present disclosure is shown. In this embodiment, washer and dryer sheet 100 includes a substrate 101, a washer composition 102, and a dryer composition 103. Substrate 101 may include any type of substrate known in the art of washer and dryer sheets, such as, for example, a polyester substrate capable of retaining washer and dryer compositions 102 and 103, respectively.

Washer composition 102 may be formed from various components used in the clothes washing industry. Examples of such components may include surfactants and antiredeposition aids. In certain embodiments of the present disclosure, washer composition 102 may include more than one surfactant, such as a primary and secondary surfactant. In still other embodiments, washer composition 102 may include three or more surfactants. Those of ordinary skill in the art will appreciate that the number of surfactants used may vary based on the relative weight percentages of other components of washer composition 102. For example, in certain embodiments, washer composition 102 may include about 25.0 weight percent to about 75.0 weight percent of a primary surfactant, and 2.0 weight percent to about 25.0 weight percent of a secondary surfactant. Washer composition 102 may also include about 2.0 weight percent of an antiredeposition aide, and about 2.0 weight percent to about 20.0 weight percent neutral sodium silicate to control the alkalinity of the composition during a wash cycle.

In still other embodiments, a washer composition 102 may include about 50.0 weight percent to about 70.0 weight percent of a primary surfactant and about 2.5 weight percent to about 7.5 weight percent of a secondary surfactant. Such a washer composition 102 may further include about 2.0 weight percent to about 6.0 weight percent of an antiredeposition aid, and about 5.0 weight percent to about 15.0 weight percent of neutral sodium silicate. Additionally, depending on the specific washer composition 102, the composition may also include processing aids. In embodiments including processing aids, the processing aids may form about 5.0 weight percent to about 15.0 weight percent of washer composition 102.

The primary and secondary surfactants may include various surfactants that are appropriate for washing objects in various temperature fluids, and in water having various hardness levels. Additionally, because residual surfactant may be disposed throughout substrate 100 during both the wash cycle and dry cycle, the surfactant may remain dry, thereby allowing the surfactant to adhere to the washer and dryer sheet 100 and not rub or flake off during washing and/or drying. Examples of primary surfactants that may be used in washer composition 102 may include alkyl benzene sulfonates, alkyl sulfates with an alkyl chain of C10-C18, alkyl ether sulfates with an alkyl chain of C10-C18, alkyl amide with an alkyl chain of C10-C18, as well as other surfactants known in the art. Examples of secondary surfactants may include alkyl betaines with an alkyl chain of C10-C18 and ethoxylated alcohols with a carbon chain length of 8 to 18 carbon atoms with an ethylene oxide content of 6 to 20 moles.

Additionally, various antiredeposition aids, which prevent the redeposition of foreign substances, such as dirt and grease, onto the object being cleaned may be used. Examples of antiredeposition aids that may be used in washer composition 102 may include carboxymethyl cellulose, polyacrylates, polyphosphates, and other antiredeposition aids known in the art.

Washer composition 102 may also include other processing aides. Examples of processing aids may include various chemical binders and builders, such as, for example, organic phosphates, such as trisodium phosphate (“TSP”), tetra potassium pyrophosphate (“TKPP”), and tetrasodium pyrophosphate (“TSPP”), silicates, such as neutral sodium silicate, hydrated sodium metasilicate, potassium silicates, light soda ash, sodium carbonate, etc.

In addition to washer composition 102, washer and dryer sheet 100 may also include a dryer composition 103. Dryer composition 103 may include various anti-static agents, such as fabric softeners. In certain embodiments, substantially one-hundred weight percent of dryer composition 103 may be an anti-static agent or fabric softener. In such embodiments, the fabric softener may include a one-hundred percent active fabric softener. In other embodiments, it may be necessary for dryer composition 103 to include release agents. Release agents may be necessary when dryer composition 103 includes fabric softeners that are not one-hundred percent active. The release agent may facilitate fabric softener release during a drying cycle. Thus, in certain embodiments, dryer composition 103 may include about 55.0 weight percent to about 75.0 weight percent fabric softener, and about 25.0 percent to about 45.0 weight percent release agent. Examples of fabric softeners that may be used may include amino ethyl ethanol amides with an alkyl chain from C10 to C20, quaternary amides with an alkyl chain from C10 to C20, di hydrogenated tallow dimethyl ammonium chloride, quaternary alkoxyammonium salts, alkyl ammonium carbamate with an alkyl chain from C10 to C20, and other fabric softeners known in the art.

Substrate 100, onto which washer composition 102 and dryer composition 103 may be applied, may include a fabric weight from 1.0 to 5.0 ounces/square yard, and may include polyesters, rayon, polypropylene, etc. Additionally, various fabric formats may be used, such as spun-bond, needlepunch, and other non-woven fabrics. Thus, substrate 100 may include various fabrics, open cell rubbers, or plastic foams capable of holding washer composition 102 and dryer composition 103. In certain embodiments, it may be beneficial to use a non-woven substrate having fine denier fibers (e.g., 6 or less denier), which may thereby provide a maximum surface area for adhesion of the washer composition 102 and dryer composition. Such substrates 101 may also promote the dissolution of washer composition 102 during the early stages of the wash cycle.

Washer composition 102 and dryer composition 103 may be disposed on substrate 101 in various configurations. For example, washer composition 102 and dryer composition 103 may be disposed on substrate 101 in discrete clusters, such as illustrated in FIG. 1. Alternatively, washer composition 102 and dryer composition 103 may be disposed throughout substrate 101 evenly. During manufacturing, dryer composition 103 may initially be applied to substrate 101 in a first layer, and washer composition 102 applied thereafter in a second layer, such that during use, washer composition 102 releases during the wash cycle, while dryer composition 103 releases during the drying cycle.

Referring briefly to FIG. 2, an alternate washer and dryer sheet 200 according to embodiments of the present disclosure is shown. In this embodiment, washer and dryer sheet 200 includes a substrate 201, a washer composition layer 202, and a dryer composition layer 203. As illustrated, washer composition layer 202 is disposed on a first side of the substrate 201, while dryer composition layer 203 is disposed on a second side of the substrate 201 opposite the first side of the substrate 201. In such an embodiment, washer composition layer 202 and dryer composition layer 203 may be applied to substrate 201 discretely, thereby allowing for the independent release of the chemicals contained therein.

Referring back to FIG. 1, additional additives may be included in either washer composition 102 or dryer composition 103. For example, in certain embodiments, general anti-static substances may be added to dryer composition 103. Examples of anti-static substances may include monoester and diesters of phosphoric acids, ethoxylated fatty alcohols with an alkyl chain from C10 to C20, ethoxylated phosphate esters, ethoxylated fatty amines with an alkyl chain from C10 to C20, and other anti-static substances known in the art. Other additives may include olfactory compositions. Such olfactory compositions may be used to impart a particular scent to an object during either a wash or dry cycle. As such, olfactory compositions may be added to either washer composition 102 or dryer composition 103. Still other additives may include certain chelating agents. Exemplary chelating agents may include ethylene diamine disuccinic acid, alkyl phosphonates with a carbon chain length of C8 to C10, as well as various salts of citric acid. Other additives may include optical brighteners. Examples of optical brighteners may include about 0.5 weight percent to about 3.0 weight percent Di, tri, or hexa sulfonated triazine stilbenes or benzoxazolines.

In addition to the chemicals of substrate 101, washer composition 102, and dryer composition 103, described above, each of the substrate 101, washer composition 102, and dryer composition 103 may include visual indicators. Examples of visual indicators may include, for example, colors and/or patterns, which may become visible to a user of the washer and dryer sheet 100 when used in a wash and/or dry cycle. In certain embodiments, when the visual indicators are colors, each of the substrate 101, washer composition 102, and dryer composition 103 may be different colors. As such, a user may be able to detect whether residual washer composition 102 and/or dryer compositions 103 remain on washer and dryer sheet 100 after use in wash and/or dry cycles.

For example, in use, a user may insert washer and dryer sheet 100 with one or more objects into a washing machine. During the wash cycle, the washer composition 102 may be substantially removed from the washer and dryer sheet 100 due to interaction with fluids, such as water, in the washing machine. As a result of the removal of washer composition 102, the washer and dryer sheet 100 may change color, for example changing to the color of dryer composition 103. Subsequently, the user may insert washer and dryer sheet 100 along with one or more of the objects into a dryer. In the dryer, heat applied to washer and dryer sheet 100 may activate dryer composition 102, thereby releasing the chemicals thereof. As the chemicals release from dryer composition 102, washer and dryer sheet 100 may lose the color of dryer composition 102, thereby resulting in the only color displayed being the color of substrate 101.

In certain embodiments, the visual indicators of one or more of the washer composition 102, dryer composition 103, and/or substrate 101 may be the same. For example, substrate 101 and washer composition 102 may be the same color, such that the user knows when the washer composition 102 has been substantially released, because washer and dryer sheet 100 will appear the color of dryer composition 102. The user may then use washer and dryer sheet 100 in a drying cycle, in which washer and dryer sheet 100 may revert to the original color, which is also the color of substrate 101. Thus, depending on the requirements of a particular use, the substrate 101, washer composition 102, and dryer composition 103 may include first, second, and third respective visual indicators. However, in certain embodiments, any two of the visual indicators may be substantially the same.

The dyes used to provide the visual indicator for substrate 101, washer composition 102, and/or dryer composition 103 may include direct dyes, disperse dyes, fiber reactive dyes, or other dyes capable of providing specific colors to one or more of the substrate 101, washer composition 102, and/or dryer composition 103, such as, for example, nonionic polymeric colorants in various colors. Additionally, in certain embodiments, one or more of the substrate 101, washer composition 102, and/or dryer composition 103 may remain in a native state. Said another way, one or more of the substrate 101, washer composition 102, and/or dryer composition 103 may not include an added dye, thereby retaining the layers natural coloration. Those of ordinary skill in the art will appreciate that the individual dyes may be mixed into the specific components during formulation thereof. As such, during the manufacture of washer and dryer sheet 100, the substrate 101, washer composition 102, and/or dryer composition 103 may be pre-colored prior to forming waster and dryer sheet 100.

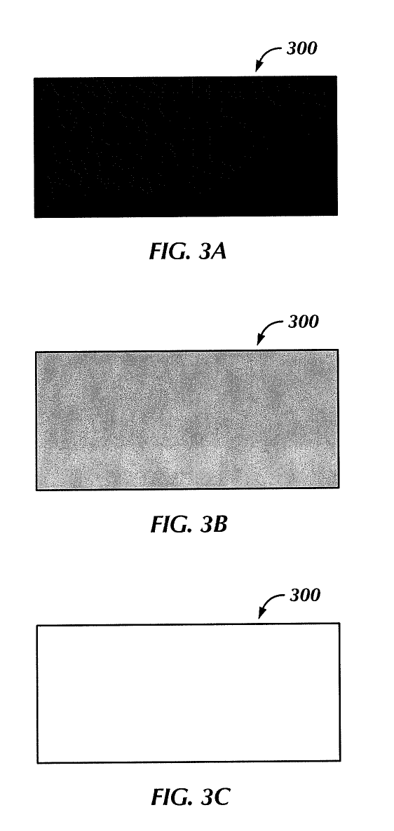

Referring to FIGS. 3A-3C, an exemplary progression of a washer and dryer sheet 300 during a wash cycle and dry cycle is illustrated. Prior to a wash cycle, washer and dryer sheet 300 includes a first visual indicator, in the instant case, a particular color (FIG. 3A). Washer and dryer sheet 300 may thereafter be used in a wash cycle. As the washer and dryer sheet 300 contacts water, and a washer composition is released therefrom, washer and dryer sheet 300 may display a second visual indicator, in the form of a second color (FIG. 3B). After the wash cycle, washer and dryer sheet 300 may be used in a drying cycle. During the drying cycle, heat may be applied to washer and dryer sheet 300, thereby releasing a dryer composition from washer and dryer sheet 300. When the washer and dryer sheet 300 is subsequently removed from the drying cycle, a third visual indicator may be displayed, in the form of a third color (FIG. 3C). In such an embodiment, one or more of the colors of the visual indicator may be in a native state. For example, in certain embodiments, the substrate may not have been dyed, and as such, the third visual indicate may be a native visual indicator as illustrated in FIG. 3C. In other embodiments, the substrate may have been dyed, and as such, the third visual indicator may not be native.

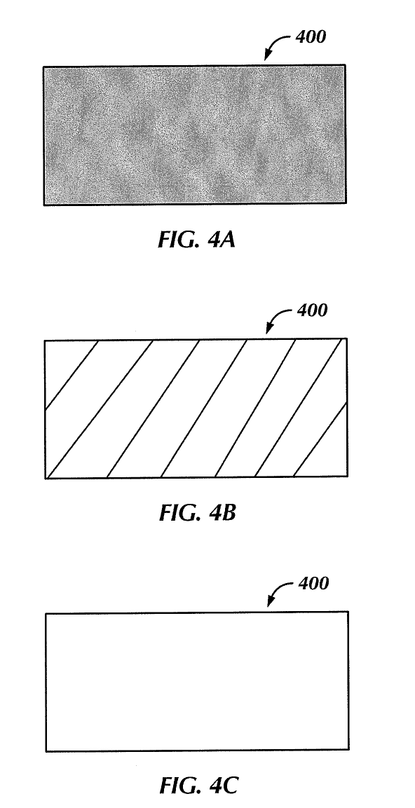

Referring to FIG. 4A-4C an alternative exemplary progression of a washer and dryer sheet 400 during a wash cycle and dry cycle is illustrated. Prior to a wash cycle, washer and dryer sheet 400 includes a first visual indicator, in the instant case, a particular color (FIG. 4A). Washer and dryer sheet 400 may thereafter be used in a wash cycle. As the washer and dryer sheet 400 contacts water, and a washer composition is released therefrom, washer and dryer sheet 400 may display a second visual indicator, in the form of a pattern (FIG. 4B). After the wash cycle, washer and dryer sheet 400 may be used in a drying cycle. During the drying cycle, heat may be applied to washer and dryer sheet 400, thereby releasing a dryer composition from washer and dryer sheet 400. When the washer and dryer sheet 400 is subsequently removed from the drying cycle, a third visual indicator may be displayed, in the form of a second color (FIG. 4C). As such, combinations of colors and patterns may be used as visual indicators according to embodiments of the present disclosure.

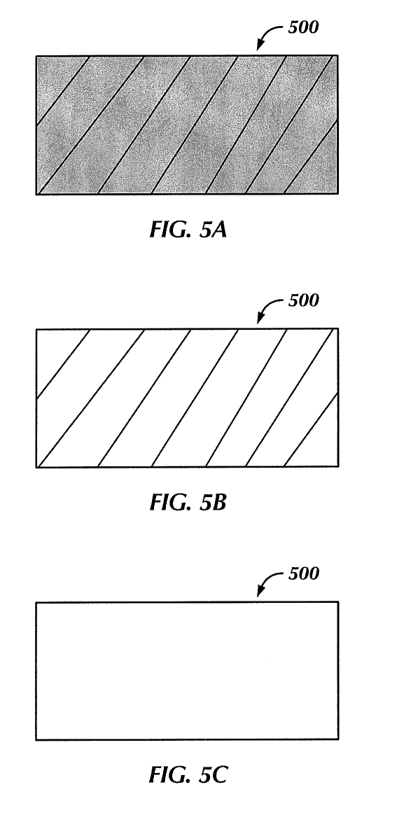

Referring to FIG. 5A-5C, an alternative exemplary progression of a washer and dryer sheet 500 during a wash cycle and a dry cycle is illustrated. Prior to a wash cycle, washer and dryer sheet 500 includes a first visual indicator, in the instance case, a particular color and pattern (FIG. 5A). Washer and dryer sheet 500 may thereafter be used in a wash cycle. As the washer and dryer sheet 500 contacts water, and a washer composition is released therefrom, washer and dryer sheet 500 may display a second visual indicator, in the form of a pattern (FIG. 5B). After the wash cycle, washer and dryer sheet 500 may be used in a drying cycle. During the drying cycle, heat may be applied to washer and dryer sheet 500, thereby releasing a dryer composition from washer and dryer sheet 500. When the washer and dryer sheet 500 is subsequently removed from the drying cycle, a third visual indicator may be displayed, whereby the third visual indicator is the absence of a particular color or pattern (FIG. 4C). Those of ordinary skill in the art will appreciate that various combinations of colors and patterns may be used as visual indicators. As such, the visual indicators may include various combinations of color, patterns, as well as colors and patterns.

During the use of washer and dryer sheets according to embodiments of the present disclosure, a user may dispose a washer and dryer sheet having at least two visual indicators in a washing machine. The washer and dryer sheet may be added to the washing machine with one or more objects, such as articles of clothing. The user may then cause the washer and dryer sheet to be contacted by water, such as during a wash cycle. During the wash cycle, the exposure of a washer composition layer of the washer and dryer sheet to water may thereby cause activation of at least one of the two visual indicators. After the wash cycle, the washer and dryer sheet, along with the one or more objects, may be removed from the washing machine. The washer and dryer sheet, along with the one or more objects, may thereafter be exposed to a heat source, such as during a dry cycle in a dryer. During the dry cycle, the exposure of the washer and dryer sheet to heat may thereby activate at least one of the two visual indicators. Thus, upon removal of the washer and dryer sheet from the heat source, a user may be able to determine whether a dryer composition is substantially removed.

At multiple stages of the wash and dry cycle explained above, the user may be able to determine the composition of the washer and dryer sheet. For example, after the wash cycle, but before the dry cycle, the user may be able to determine whether substantially all of the surfactant of the washer composition has been removed from the washer and dryer sheet. Such a determination may occur through observation of a color change of the washer and dryer sheet as a result of dye in the washer composition being released in the wash. Similarly, after the dry cycle a user may be able to determine whether substantially all of the fabric softener has been used by observing a second color change of the washer and dryer sheet.

In certain embodiments, to determine whether substantially all of the washer and dryer compositions have been removed, the washer and dryer sheet may include three visual indicators, such as in the form of three colors or patterns. As such, a user may be able to determine whether a surfactant and a fabric softener have been removed from the washer and drying sheet by observing the exposure of a third visual indicator.

Advantageously, embodiments of the present disclosure may provide methods of ensuring that softening of fabrics occurs in the drying cycle instead of allowing washer composition components to be released in the drying cycle. Because the washer and dryer sheets disclosed herein include visual indicators, a user may be able to ensure that the proper washer and dryer components are released at the proper stage of wash and dry cycles. Such indicators may thereby allow for more effective wash and dry cycles resulting in an increased quality of washed and dried objected.

Also advantageously, because a user may be able to tell when substantially all of a washer or dryer composition is released during wash and dry cycles, a user may be able to reuse the washer and dryer sheets in subsequent wash or dry cycles.

While the present disclosure has been described with respect to a limited number of embodiments, those skilled in the art, having benefit of this disclosure, will appreciate that other embodiments may be devised which do not depart from the scope of the disclosure as described herein. Accordingly, the scope of the disclosure should be limited only by the attached claims.

What is claimed:

1. A washer and dryer sheet comprising:
a substrate comprising a first visual indicator;
a washer composition comprising a second visual indicator, wherein the second visual indicator is removed during a wash cycle; and
a dryer composition comprising a third visual indicator, wherein the third visual indicator is removed during a dry cycle.

2. The washer and dryer sheet of claim 1, wherein the first, second, and third visual indicators comprise a color.

3. The washer and dryer sheet of claim 2, wherein the first, second, and third colors are all different.

4. The washer and dryer sheet of claim 1, wherein the washer composition is disposed on one side of the substrate.

5. The washer and dryer sheet of claim 4, wherein the dryer composition is disposed on an opposite side of the substrate from the side where the washer composition is disposed.

6. The washer and dryer sheet of claim 1, wherein the washer composition and dryer compositions are disposed throughout the substrate.

7. The washer and dryer sheet of claim 1, wherein the washer composition and dryer compositions are disposed discretely throughout the substrate.

8. The washer and dryer sheet of claim 1, wherein the washer composition comprises:
about 25.0 weight percent to about 75.0 weight percent of a primary surfactant;
about 2.0 weight percent to about 25.0 weight percent of a secondary surfactant;
about 2.0 weight percent to about 20 weight percent neutral sodium silicate;
about 2.0 weight percent to about 12.0 weight percent of an antiredeposition aide.

9. The washer and dryer sheet of claim 8, wherein the dryer composition comprises:
a fabric softener.

10. The washer and dryer sheet of claim 9, wherein the dryer composition further comprises:
a release agent.

11. The washer and dryer sheet of claim 10, wherein the primary and secondary surfactants remain dry during the wash cycle.

12. The washer and dryer sheet of claim 1, wherein the third visual indicator is removed from the sheet due to exposure to heat.

13. The washer and dryer sheet of claim 1, wherein the second visual indicator is removed from the sheet due to exposure to water.

14. The washer and dryer sheet of claim 1, wherein at least one of the first, second, and third visual indicators are the same.

15. The washer and dryer sheet of claim 1, wherein the washer and dryer sheet further comprises:
an olfactory composition.

16. A method of washing and drying an object, the method comprising:
disposing a washer and dryer sheet having at least two visual indicators in a washing machine;
contacting the object and the washer and dryer sheet with water;
removing the washer and dryer sheet from the washing machine; and
exposing the object and the washer and dryer sheet to a heat source.

17. The method of claim 16, further comprising:
determining whether a surfactant has been removed from the washer and dryer sheet, wherein the determining comprises observing a color change of the washer and dryer sheet.

18. The method of claim 16, further comprising:
determining whether a fabric softener has been removed from the washer and dryer sheet, wherein the determining comprises observing a second color change of the washer and dryer sheet.

19. The method of claim 16, wherein the visual indicator comprises a color.

20. The method of claim 19, wherein the washer and dryer sheet further comprises a third visual indicator.

21. The method of claim 19, further comprising:
determining a surfactant and a fabric softener have been removed from the washer and drying sheet, wherein the determining comprises exposing the third visual indicator.
